(19) United States
(12) Patent Application Publication
(10) Pub. No.: US 2023/0327164 A1
(43) Pub. Date: Oct. 12, 2023

(54) FUEL CELL AND FUEL CELL STACK

(71) Applicant: Hitachi, Ltd., Tokyo (JP)

(72) Inventors: Ryuusei FUJITA, Tokyo (JP); Yoshitaka SASAGO, Tokyo (JP); Noriyuki SAKUMA, Tokyo (JP); Natsuki YOKOYAMA, Tokyo (JP)

(21) Appl. No.: 18/112,693

(22) Filed: Feb. 22, 2023

(30) Foreign Application Priority Data
Apr. 8, 2022 (JP) 2022-064835

(51) Int. Cl. H01M 8/1286; H01M 8/1253; H01M 8/1226; H01M 8/1231; H01M 8/248; H01M 8/2457

(52) U.S. Cl. CPC H01M 8/1286; H01M 8/1253; H01M 8/1226; H01M 8/1231; H01M 8/248; H01M 8/2457; H01M 2008/1293

(57) ABSTRACT

An object of the present invention is to provide a fuel cell that obtains high output density and prevents stress application to the cell during stack assembling and breakage. The fuel cell is equipped with a unit cell including a structure in which an electrolyte layer is sandwiched between an anode electrode layer and a cathode electrode layer. The unit cell is disposed between a first member and a second member. An intermediate substrate is disposed between the first member and the second member. The unit cell is supported at the outer peripheral portion thereof by the intermediate substrate. The width of the electrolyte layer is the maximum width or less of a hollow portion formed between at least one of the first member and the second member and the unit cell.

### BACKGROUND

The present invention relates to a fuel cell using a solid electrolyte.

Attention has recently been focused on a fuel cell as a power generation system that uses a fuel, such as hydrogen, and does not exhaust carbon dioxide. The fuel cell has a structure in which an electrolyte is sandwiched between two anode and cathode electrodes, and performs the power generation operation by supplying a fuel gas to the anode side and supplying a gas containing oxygen, such as air, to the cathode side.

To safely and efficiently take out the generated power to the outside, assembled is a stack that has, as components, an electric collector that is made of a metal of a mesh structure serving as electric connection and gas permeation, a separator that separates a fuel gas flow passage and an air flow passage, a gasket for preventing gas leakage to the outside, and the like, and compression stress is applied from the up and down sides by screw fastening and the like, so that the sealability is improved and the contact electric resistance is reduced.

In addition, there has also been known a technique by which a fuel battery cell is accommodated by two supporting substrates to improve the electric collection performance (Japanese Unexamined Patent Application Publication No. 2010-205534).

In addition, there has also been known a battery cell that includes an electrode layer at a position covering an opening formed in a supporting substrate and includes a solid electrolyte layer having a thickness of 1000 nm or less, the electrode layer being porous in at least part of the region thereof covering the opening (WO 2021/090441 A1).

### SUMMARY

As the electrolyte layer is made thinner, the output of the fuel battery cell is more improved, but the mechanical strength becomes lower, so that breakage, such as a crack, is likely to be caused.

Japanese Unexamined Patent Application Publication No. 2010-205534 has the structure in which in a state where the lower face of the cell is entirely in contact with one supporting substrate, the other supporting substrate comes into contact also with the outer peripheral portion of the upper face of the cell, so that when the electrolyte layer is made to be a thin film of, for example, 1 μm or less, to obtain high output density, the electrolyte can be broken by the compression stress during stack assembling. This is required to be avoided since the breakage of the electrolyte layer leads directly to the failure of the cell.

WO 2021/090441 A1 discloses the cell including the electrolyte layer having the thickness of 1000 nm or less, but has not studied the stress applied to the electrolyte layer through the separator.

The present invention has been made in view of the problems as described above, and an object of the present invention is to provide a fuel cell that obtains high output density and prevents stress application to the cell during stack assembling and breakage.

One aspect of the present invention is a fuel cell that is equipped with a unit cell including a structure in which an electrolyte layer is sandwiched between an anode electrode layer and a cathode electrode layer. The unit cell is disposed between a first member and a second member. An intermediate substrate is disposed between the first member and the second member. The unit cell is supported at the outer peripheral portion thereof by the intermediate substrate. The width of the electrolyte layer is the maximum width or less of a hollow portion formed between at least one of the first member and the second member and the unit cell.

Another aspect of the present invention is a fuel cell that is equipped with a unit cell including a structure in which an electrolyte layer is sandwiched between an anode electrode layer and a cathode electrode layer. The unit cell is disposed between a first member and a second member. An intermediate substrate is disposed between the first member and the second member. The unit cell is supported at the outer peripheral portion thereof by the intermediate substrate. The thickness of the electrolyte layer is 1 μm or less.

A further aspect of the present invention is a fuel cell stack that has the fuel cell and applies compression stress from the up and down sides of the entire fuel cell.

According to the present invention, it is possible to provide the fuel cell that obtains the high output density and prevents the stress application to the cell during the stack assembling and the breakage.

### BRIEF DESCRIPTION OF THE DRAWINGS

FIG. 1 is a cross-sectional view of a fuel cell of a first example;

FIG. 2 is a cross-sectional view illustrating the definition of the width of a hollow portion according to the example;

FIG. 3 is a perspective view of the respective components of the fuel cell of the first example;

FIG. 4 is a cross-sectional view of a fuel cell stack of the first example;

FIG. 5 is a cross-sectional view of a fuel cell stack of a second example;

FIG. 6 is a cross-sectional view of the fuel cell of a fourth example;

FIG. 7 is a cross-sectional view of the fuel cell of a fifth example;

FIG. 8 is a cross-sectional view of the fuel cell of a sixth example;

FIG. 9 is a cross-sectional view of the fuel cell of a seventh example;

FIG. 10 is a cross-sectional view of the fuel cell of an eighth example;

FIG. 11 is a cross-sectional view of the fuel cell of a tenth example;

FIG. 12A is a cross-sectional view of the fuel cell of an eleventh example;

FIG. 12B is a perspective view of an intermediate substrate of the eleventh example;

FIG. 13 is a perspective view of the respective components of the fuel cell of a twelfth example;

FIG. 14 is a perspective view of the intermediate substrate of a thirteenth example;

FIG. 15 is a cross-sectional view of the fuel cell of a fourteenth example;

FIG. 16A is a cross-sectional view of the fuel cell of a fifteenth example;

FIG. 16B is a perspective view of the intermediate substrate of the fifteenth example;

FIG. 17 is a cross-sectional view of the fuel cell of a sixteenth example;

FIG. 18 is a cross-sectional view of the fuel cell of a seventeenth example;

FIG. 19A is a cross-sectional view of the fuel cell of an eighteenth example; and

FIG. 19B is a perspective view of the intermediate substrate of the eighteenth example.

### DETAILED DESCRIPTION

An embodiment of the present invention will be described below in detail with reference to the drawings. The following embodiment will be described by being divided into a plurality of sections or embodiments when it is necessary for convenience, but except for the case of being particularly specified, they are not independent of one another, and are in a relationship in which one is the modification example, the detail, the supplementary explanation, and the like in part or in whole of the others. In addition, in the drawings used in the following embodiment, even the plan view may also be indicated by hatching for simplifying the drawing. In addition, in all the drawings for describing the following embodiment, those having the same functions are indicated by the same reference numerals as a rule, and the repeated description thereof is omitted. In addition, to simplify the drawings, those having the same functions in the mutual cross-sectional views may be indicated by the same hatching in the same shapes to omit the reference numerals.

One fuel cell according to an example is a fuel cell that is equipped with a unit cell including a structure in which an electrolyte layer is sandwiched between an anode electrode layer and a cathode electrode layer. The unit cell is supported at the outer peripheral portion thereof by an intermediate substrate. The width of the electrolyte layer is the maximum width or less of a hollow portion.

One fuel cell according to an example is a fuel cell that is equipped with a unit cell including a structure in which an electrolyte layer is sandwiched between an anode electrode layer and a cathode electrode layer. The unit cell is supported at the outer peripheral portion thereof by an intermediate substrate. The thickness of the electrolyte layer is 1 μm or less.

### Example 1

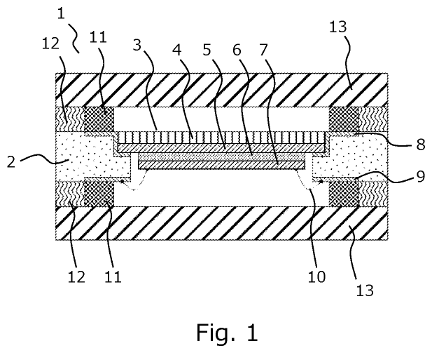

FIG. 1 is a cross-sectional view illustrating an example of the structure of the fuel cell of a first example of the present invention. A fuel cell 1 of the first example is equipped with at least one unit cell 3 (hereinafter, also simply called a cell) on an intermediate substrate 2. The unit cell 3 includes a porous support layer 4, an anode electrode layer 5, an electrolyte layer 6, and a cathode electrode layer 7, the electrolyte layer 6 being sandwiched between the anode electrode layer 5 and the cathode electrode layer 7. Depending on the case, the porous support layer 4 may also be omitted.

The intermediate substrate 2 is an insulator, and is desirably made of a material having constant mechanical strength even at high temperature, such as an aluminum oxide, a zirconium oxide, and silicon nitride. A first conductive region 8 and a second conductive region 9 are provided to the intermediate substrate 2 by, for example, forming a metal material of gold or silver by a printed wiring technique.

When to manufacture the high output density cell, the anode electrode layer 5, the electrolyte layer 6, and the cathode electrode layer 7 are made to be a thin film of, for example, 1 μm and the like, the porous support layer 4 serves to support the entire cell. As the material of the porous support layer 4, a ceramic material, such as an aluminum oxide, is used, and in addition, the porous support layer 4 is made to have a porous structure, so that a fuel gas reaches the anode electrode layer 5. The anode electrode layer 5 is made of a material, such as a cermet of nickel and stabilized zirconia, and is electrically connected to the first conductive region 8 by a conductive paste and the like.

As illustrated in FIG. 1, the range of the electrolyte layer 6 and the cathode electrode layer 7 is made narrower than the anode electrode layer 5, so that it is also possible to face the cathode electrode layer 7 downward to bring the anode electrode layer 5 into contact with the first conductive region 8, to allow the cathode electrode layer 7 not to be brought into contact with the first conductive region 8, and to accommodate the cell in the counterbore portion of the intermediate substrate 2. When the lower face of the anode electrode layer 5 is exposed, it is desirably shielded by a glass seal material and the like so that it is not exposed to air.

The electrolyte layer 6 is made of a material, such as stabilized zirconia in which the composition ratio of yttria is 8% (yttria stabilized zirconia). When the electrolyte layer 6 is made to be the thin film of 1 μm or less by a film formation process, such as sputtering, power generation at high output density can also be obtained. The cathode electrode layer 7 is made of a material, such as platinum, a cermet of platinum and GDC (Gadolinium. Doped Ceria), and LSC ((La, Sr) CoO3), and is electrically connected to the second conductive region 9 by a bonding wire 10 and the like.

An electric collector 11 is disposed to be in contact with each of the first conductive region 8 and the second conductive region 9. This is made of a conductive material, such as nickel and silver, but the electric collector 11 disposed on the air flow passage side is desirably made of a material that is not oxidized also at high temperature. A gasket 12 is disposed on the outside of the electric collector 11. The electric collectors 11 and the gaskets 12 disposed in the up and down directions of the intermediate substrate 2 are sandwiched between two separators 13, and compression stress is applied thereto, so that gas leakage to the outside is prevented. When the electric collector 11 has a mesh structure having air holes, it has the same thickness as the gasket 12 when it is compressed, so that the sealability can be expected to be improved, and at the same time, satisfactory electric connection with the conductive region can also be made. It should be noted that the up and down directions are referred to as directions in which the respective layers are stacked and that the up direction and the down direction can be replaced.

The separator 13 is made of a material, such as stainless steel, and is electrically connected to each of the first conductive region 8 and the second conductive region 9 through the electric collector 11, so that the taking-out of the generated power of the unit cell 3 to the outside is achieved. At this time, only the intermediate substrate 2 is the portion with which the electric collector 11 is overlapped, and the width of the electrolyte layer 6 is brought into the state of being the maximum width or less of the hollow portion, so that when the fuel cell 1 is pressurized from the up and down sides, stress application to the cell and further the breakage of the cell can be prevented.

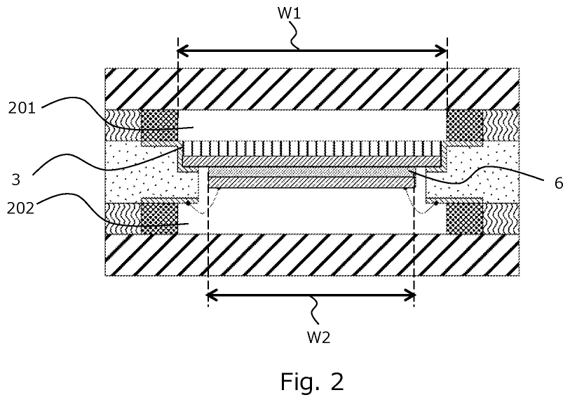

FIG. 2 illustrates the definition of the width of the hollow portion of the fuel cell 1 according to the example. No components are disposed on the up and down sides of the unit cell 3, which causes hollow portions 201, 202. The maximum value of the width of the hollow in the cross section is W1 in each of any cross sections of the hollow portions. In addition, the maximum value of the width of the electrolyte layer 6 in the same cross section is W2. The compression stress is received from the upper and lower separators 13 during stack assembling, but when the value of W2 is W1 or less in any cross section parallel to the stress application direction, the stress is not applied to the electrolyte layer 6, so that the breakage can be prevented.

For example, in the cross section illustrated in FIG. 2, since the maximum width of the electrolyte layer 6 is smaller than the maximum width of the upper hollow portion 201, the force applied from the up side to the down side is not applied to the electrolyte layer 6. In addition, since the maximum width of the electrolyte layer 6 is smaller than the maximum width of the lower hollow portion 202, the force applied from the down side to the up side is not applied to the electrolyte layer 6.

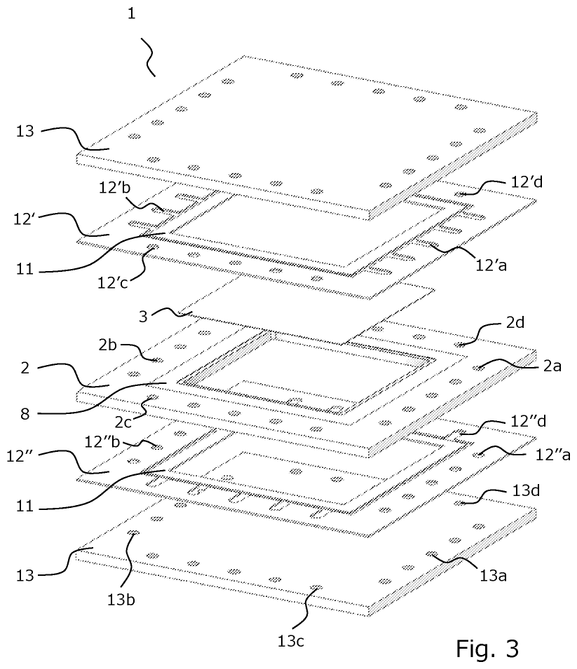

FIG. 3 is a perspective view illustrating an example of the structure of the fuel cell of the first example of the present invention. In the unit cell 3, the cathode electrode layer is faced downward, and as illustrated in FIG. 1, the range of the electrolyte layer 6 and the cathode electrode layer 7 is made narrower than the anode electrode layer 5, so that the anode electrode layer 5 can be brought into contact with the first conductive region 8. In such a case, a fuel is required to be supplied to the up side of the unit cell 3, and air is required to be supplied to the down side of the unit cell 3. In this description, the gasket 12 disposed on the intermediate substrate 2 is distinguished as an anode side gasket 12′, and the gasket 12 disposed below the intermediate substrate 2 is distinguished as a cathode side gasket 12″.

The intermediate substrate 2 has a fuel flow inlet 2a, a fuel flow outlet 2b, an air flow inlet 2c, and an air flow outlet 2d. Likewise, the gasket 12′ is provided with a fuel flow inlet 12′a, a fuel flow outlet 12′b, an air flow inlet 12′c, and an air flow outlet 12′d, the gasket 12″ is provided with a fuel flow inlet 12″a, a fuel flow outlet 12′b, an air flow inlet 12″c, and an air flow outlet 12″d, and the separator 13 is provided with a fuel flow inlet 13a, a fuel flow outlet 13b, an air flow inlet 13c, and an air flow outlet 13d.

When the fuel gas is supplied from the fuel flow inlet 13a of the lower stage separator 13, the fuel gas goes upward while passing through the fuel flow inlet 12″a of the cathode side gasket 12″ and the fuel flow inlet 2a of the intermediate substrate 2. At this time, the fuel gas can be supplied to the up side of the unit cell 3 by providing a cutout portion in the fuel flow inlet 12′a of the anode side gasket 12′. Thereafter, the fuel gas is discharged to the outside through the fuel flow outlet 12′b of the anode side gasket 12′, the fuel flow outlet 2b of the intermediate substrate 2, and the fuel flow outlet 13b of the separator 13. In addition, when the similar structure is further repeated on the upper stage separator 13, the fuel gas passes through the fuel flow inlet 13a of the upper stage separator 13, and is supplied upward.

Likewise, when the air is supplied from the air flow inlet 13c of the lower stage separator 13, the air can be supplied to the down side of the unit cell 3 by providing a cutout portion in the air flow inlet 12″c of the cathode side gasket 12″. Thereafter, the air is discharged to the outside from the air flow outlet 13d of the separator 13 through the air flow outlet 12″d of the cathode side gasket 12″. In addition, when the similar structure is further repeated on the upper stage separator 13, the air passes through the air flow inlet 2c of the intermediate substrate 2 and the air flow inlet 12″c of the cathode side gasket 12″, and is supplied upward.

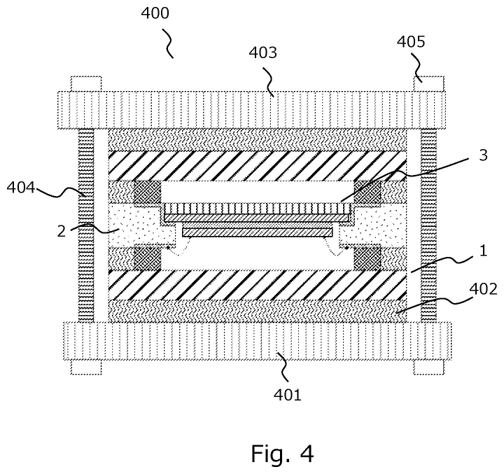

FIG. 4 is a cross-sectional view illustrating an example of the structure of a fuel cell stack of the first example of the present invention. A fuel cell stack 400 includes the fuel cell 1, a bottom face jig 401, two gaskets 402, a top face jig 403, a support pillar 404, and a fastening member 405. For at least one of the bottom face jig 401 and the top face jig 403 and the gasket 402, a flow passage and a hole such that the fuel gas and the air can move between the fuel flow inlet 13a, the fuel flow outlet 13b, the air flow inlet 13c, and the air flow outlet 13d of the separator 13 are necessary.

The fuel cell stack 400 can be assembled by stacking the bottom face jig 401, the gasket 402, the fuel cell 1, the gasket 402, the top face jig 403 in that order from the down side. Holes coinciding with the shape of the fastening member 405 are provided in the top face and the bottom face of the support pillar 404.

To prevent the leakage of the fuel gas and the air to the outside, through holes are opened in the outer peripheral portions of the bottom face jig 401 and the top face jig 403, the support pillar 404 is passed therethrough, and the fastening member 405 is fastened, so that the compression stress is applied to the fuel cell 1 from the up and down sides.

At this time, since the width of the electrolyte layer 6 is the maximum width or less of the hollow portion, the compression stress by the fastening member 405 is not applied, so that the breakage can be prevented. The compression stress by the fastening member 405 acts on the intermediate substrate 2 holding the unit cell 3, so that while the sealing of the fuel cell 1 is enabled, the breakage of the thin electrolyte layer 6 of, for example, 1 μm or less, is prevented.

### Example 2

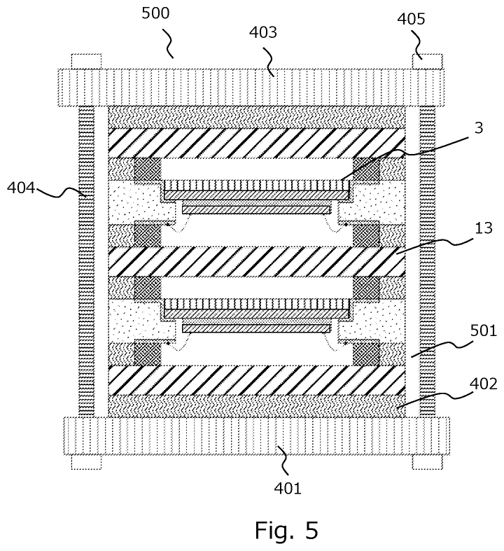

FIG. 5 is a cross-sectional view illustrating an example of the structure of a fuel cell stack of a second example of the present invention. A fuel cell stack 500 includes a fuel cell 501, the bottom face jig 401, two gaskets 402, the top face jig 403, the support pillar 404, and the fastening member 405.

The difference from the first example is that the structure of the fuel cell 1 illustrated in FIG. 1 is stacked in the vertical direction. Thus, two unit cells 3 can be connected in series, and the output voltage of the stack is increased. It should be noted that when the structure of FIG. 1 is simply stacked, two separators 13 are disposed at the middle stage, but this can be shared by one separator 13, so that the one separator 13 becomes a relay member for connecting the unit cells 3 in series and at the same time, serves to separate the fuel gas flow passage and the air flow passage. In addition, by repeatedly stacking this structure, three or more unit cells 3 can also be connected in series, and the output voltage of the stack is also increased according to the number of stacking.

Also when a plurality of structures are stacked in this way, as in the first example, the width of the electrolyte layer 6 is made to be the maximum width or less of the hollow portion, so that the stress is not applied when the stack is fastened by the fastening member 405, and the breakage can be prevented.

### Example 3

In the first and second examples, the porous support layer 4 is made of the ceramic material, but can also be made of a metal material having conductivity. For example, an alloy containing iron of 50% or more and the like are used. Thus, in the case of the ceramic material, the electric current path is provided only in the anode electrode layer 5, but the electric current flows also to the porous support layer 4, and the parasitic resistance is reduced, so that the power loss in the interior of the stack is reduced. In particular, as the film thickness of the electrolyte layer 6 is smaller, the electric current becomes larger, so that the power loss reduction effect also becomes large.

### Example 4

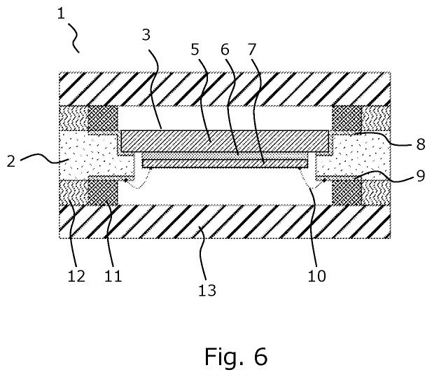

FIG. 6 is a cross-sectional view illustrating an example of the structure of the fuel cell of a fourth example of the present invention. The difference from the first to third examples is that the porous support layer 4 is absent in the unit cell 3. In the first to third examples, the cell is such that with the porous support layer 4 as a base, the anode electrode layer 5, the electrolyte layer 6, and the cathode electrode layer 7 are formed, but with the anode electrode layer 5 as a base, the electrolyte layer 6 and the cathode electrode layer 7 can also be formed. Also in this case, the width of the electrolyte layer 6 is made to be the maximum width or less of the hollow portion, so that the stress is not applied during the stack assembling, and the breakage can be prevented.

### Example 5

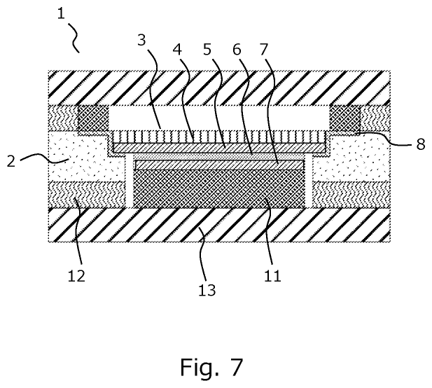

FIG. 7 is a cross-sectional view illustrating an example of the structure of the fuel cell of a fifth example of the present invention. In this example, the bonding wire 10 is not used, and the cathode electrode layer 7 is electrically connected to the separator 13 by the electric collector 11 having the mesh metal structure with the air holes.

In the first example, since the electric current directs toward the bonding wire 10, the electrons move in the horizontal direction in the interior of the cathode electrode layer 7, and the parasitic resistance corresponding to the sheet resistance of the cathode electrode layer 7 is caused, and consequently, to reduce the power loss, the film thickness of the cathode electrode layer 7 is required to be large, so that this leads to the increased manufacturing cost and the lowered throughput.

In this example, since the entire face of the cathode electrode layer 7 can be electrically connected to the separator 13, the sheet resistance of the cathode electrode layer 7 is not required to be considered, and both of the maintaining of the throughput and the reduction of the power loss can be made. This effect becomes more significant as the electrolyte layer 6 is made thinner and the electric current output is made larger.

Also in this case, the width of the electrolyte layer 6 is made to be the maximum width or less of the hollow portion, so that the stress is not applied during the stack assembling and the breakage can be prevented. The electric collector 11 has the mesh structure with the air holes, and makes the satisfactory electric connection by the expanding and shrinking properties thereof, but since nothing is disposed on the upper face of the unit cell 3 from the example of the present invention, the separation of the intermediate substrate 2 and the unit cell 3 bonded by the conductive paste and the like can be caused. For this, the thickness of the electric collector 11 is desirably designed to be sufficient so that they are not separated. In addition, like the third example, the porous support layer 4 is made of the conductive material, so that the power loss on the anode side can also be reduced.

### Example 6

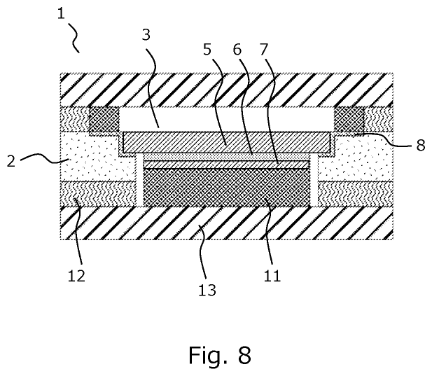

FIG. 8 is a cross-sectional view illustrating an example of the structure of the fuel cell of a sixth example of the present invention. In this example, the porous support layer 4 is absent in the unit cell 3, but like the fifth example, the structure in which by the electric collector 11 having the mesh metal structure with the air holes, the cathode electrode layer 7 is electrically connected to the separator 13 is applicable.

### Example 7

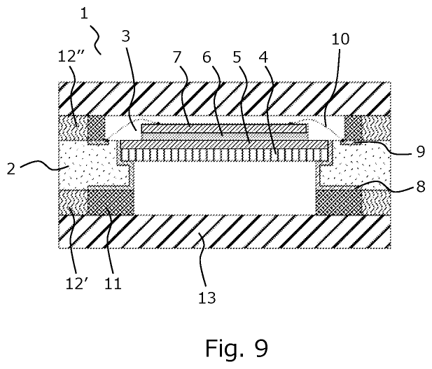

FIG. 9 is a cross-sectional view illustrating an example of the structure of the fuel cell of a seventh example of the present invention. The difference from the above examples is that the unit cell 3 is disposed so that the porous support layer 4 is faced downward and the cathode electrode layer 7 is faced upward. Therefore, the cathode side gasket 12″ is disposed on the intermediate substrate 2 and the anode side gasket 12′ is disposed below the intermediate substrate 2 so that the air flows on the up side of the unit cell 3 and the fuel gas flows on the down side of the unit cell 3.

Also in this case, the width of the electrolyte layer 6 is made to be the maximum width or less of the hollow portion, so that the stress is not applied during the stack assembling and the breakage can be prevented.

### Example 8

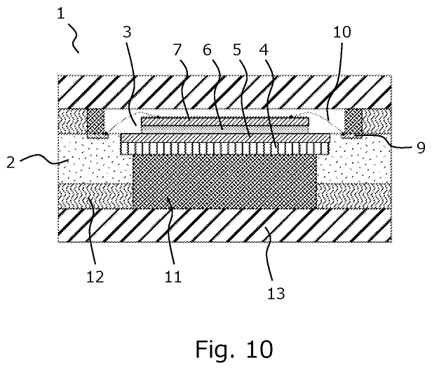

FIG. 10 is a cross-sectional view illustrating an example of the structure of the fuel cell of an eighth example of the present invention. In this example, the porous support layer 4 is made of the conductive material. For this, the lower face of the unit cell 3 is electrically connected to the anode electrode layer 5, and for example, as illustrated in FIG. 8, the electric collector 11 having the mesh metal structure with the air holes is disposed immediately below the unit cell 3, so that the electrical connection with the separator 13 can be made.

Also in this case, the width of the electrolyte layer 6 is made to be the maximum width or less of the hollow portion, so that the stress is not applied during the stack assembling and the breakage can be prevented. In addition, it is desirable that the intermediate substrate 2 and the unit cell 3 be bonded by the conductive paste and the like so as not to cause the separation.

### Example 9

In the eighth example, the porous support layer is made of the metal material, but also when the ceramic material is used, the metal is formed in the gas flow passage hole in the porous support layer, so that like FIG. 10, the electric connection to the separator 13 from the lower face of the unit cell 3 through the electric collector 11 is enabled. For the metal formation into the gas flow passage hole, for example, the metal film is formed only on the surface so as not to bury the flow passage hole, or the flow passage hole is selectively buried by the metal for division into the portion serving as the electric connection to the lower face and the portion serving as the fuel gas supply to the unit cell 3.

### Example 10

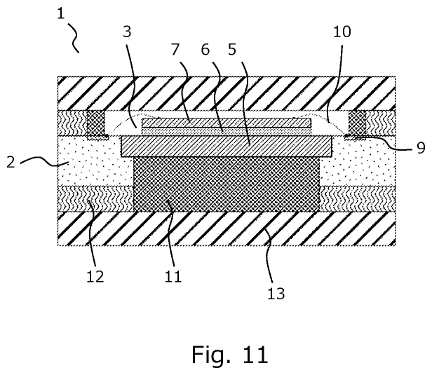

FIG. 11 is a cross-sectional view illustrating an example of the structure of the fuel cell of a tenth example of the present invention. In this example, the porous support layer 4 in the eighth example is absent. The anode electrode layer 5 is made of the conductive material, so that like the eighth example, the electric collector 11 is disposed immediately below the unit cell 3, thereby enabling the electric connection with the separator 13 to be made.

### Example 11

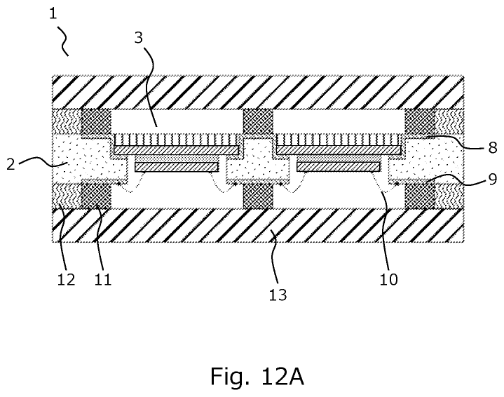

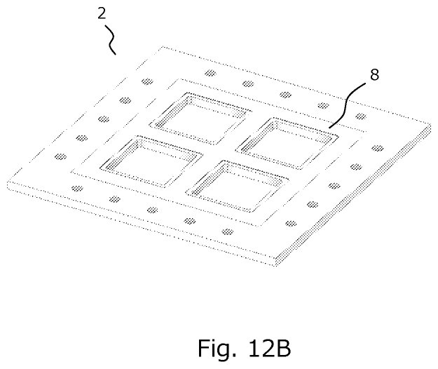

FIG. 12A is a cross-sectional view illustrating an example of the structure of the fuel cell of an eleventh example of the present invention. In this example, a plurality of unit cells 3 are mounted on one intermediate substrate 2. In view of the output density, only one unit cell 3 having a large area is desirably mounted, but as the area is larger, the risk of the breakage is increased. In particular, in the case of the solid oxide fuel cell (SOFC), the operation temperature is 600 degrees or more, and consequently, the breakage due to the thermal stress at the time of temperature rise and fall is also a concern. With respect to this, in this example, the risk of the breakage can be prevented by decreasing the area of the unit cell 3. In addition, the effect of improving the manufacturing yield is also obtained.

FIG. 12B is a perspective view illustrating an example of the structure of the intermediate substrate of the eleventh example of the present invention. In this way, a plurality of through holes and counterbore portions are provided in the intermediate substrate 2, so that the plurality of unit cells 3 can be mounted on one intermediate substrate 2.

### Example 12

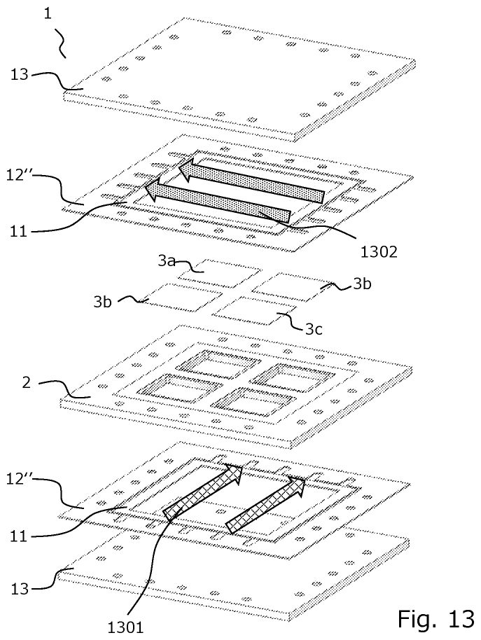

FIG. 13 is a perspective view illustrating an example of the structure of the fuel cell of a twelfth example of the present invention. Like the eleventh example, a plurality of unit cells 3 are mounted on one intermediate substrate 2, but in this example, the unit cells 3 having different characteristics are mounted. Three types of unit cells 3 having different characteristics are present, and they are respectively distinguished as a first unit cell 3a, a second unit cell 3b, and a third unit cell 3c. In addition, when they are operated under the same condition, the first unit cell 3a has larger generated power than the second unit cell 3b, and the second unit cell 3b has larger generated power than the third unit cell 3c.

When the fuel gas flow passage and the air flow passage are the same as the first example, the air flows below each unit cell 3 and the fuel gas flows above the unit cell 3. The flow of the air is indicated by an arrow 1301, and the flow of the fuel gas is indicated by an arrow 1302.

When the fuel cell is operated, the hydrogen in the fuel gas and the oxygen in the air are consumed by the chemical reaction, and as the fuel gas and the air direct toward the downstream side, the concentration thereof becomes lower. Therefore, when the characteristics of all the unit cells 3 are uniform, the power generation amount of the unit cell 3 disposed on the downstream side is lowered. Accordingly, the unit cell 3 having the good characteristic is disposed on the downstream side, so that the unbalance can be reduced.

In the case of this example, the hydrogen concentration of the two unit cells 3 on the left side and the up side is lowered, and the oxygen concentration of the two unit cells 3 on the right side and the up side is lowered, so that the unit cell 3c in which the generated power when it is operated under the same condition is the smallest is disposed on the down side, and the unit cell 3a in which the generated power when it is operated under the same condition is the largest is disposed on the up side, so that the variation in the generated power between the respective unit cells during the fuel cell operation can be prevented.

As means for controlling the characteristic of the unit cell 3, for example, the film thickness of the electrolyte layer 6 is changed. When the electrolyte layer 6 is thickened, the generated power is lowered.

### Example 13

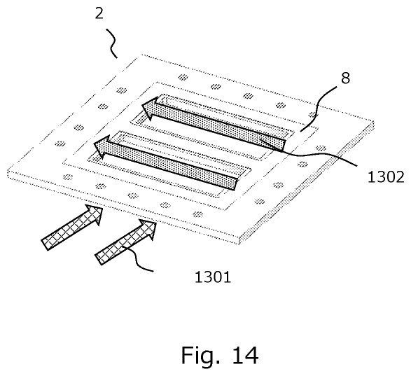

FIG. 14 is a perspective view illustrating an example of the structure of the intermediate substrate of a thirteenth example of the present invention. When a plurality of unit cells 3 are mounted on one intermediate substrate 2, the fuel flows also to the portion where the unit cells 3 are absent, and consequently, the lowered fuel usage efficiency is caused.

In this example, the through holes and the counterbore portions of the intermediate substrate 2 are made to be rectangular so as to coincide with the fuel gas flow passage, so that the lowered efficiency when the plurality of unit cells 3 are mounted can be prevented. The flow of the air on the back face of the intermediate substrate 2 is indicated by the arrow 1301. The flow of the fuel gas is indicated by the arrow 1302.

The shape of the unit cell 3 is also rectangular to coincide with the counterbore portions of the intermediate substrate 2, but in both of the longer side and the shorter side, the width of the electrolyte layer 6 is made to be the maximum width or less of the hollow portion, so that the stress is not applied during the stack assembling and the breakage can be prevented.

### Example 14

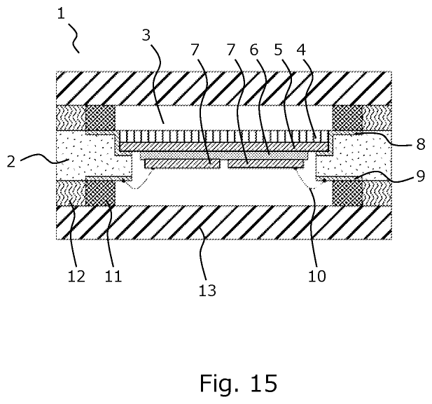

FIG. 15 is a cross-sectional view illustrating an example of the structure of the fuel cell of a fourteenth example of the present invention. The difference from the first example is that the cathode electrode layer 7 is divided, and it is also effective to divide the cathode electrode layer 7 in order to manage the manufacturing yield of the unit cell 3. Since the dimension and shape can be easily changed by the mask and the like during the film formation, there is an advantage that the degree of freedom is high as compared with the case of changing the shape of the porous support layer 4.

### Example 15

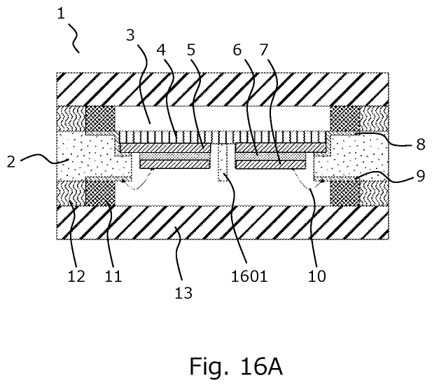

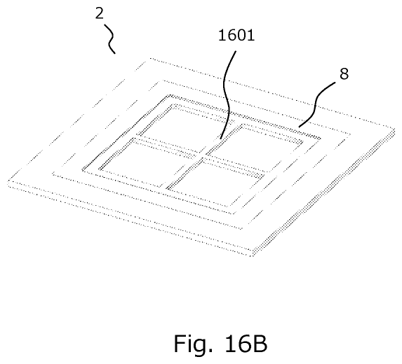

FIG. 16A is a cross-sectional view illustrating an example of the structure of the fuel cell of a fifteenth example of the present invention, and FIG. 16B is a perspective view of the intermediate substrate. In this example, the number of unit cells mounted on one intermediate substrate 2 is one, but the anode electrode layer 5, the electrolyte layer 6, and the cathode electrode layer 7 are divided, and a cell supporting portion 1601 is provided to the intermediate substrate 2. Thus, the supporting area of the unit cell 3 is increased, the deformation can be prevented when the stress bending in the down direction is caused due to the temperature change and the like, and the risk of the breakage can be reduced.

The anode electrode layer 5 is not necessarily required to be divided, and for example, when the porous support layer 4 is absent like the fourth example, only the electrolyte layer 6 and the cathode electrode layer 7 are divided, so that this example is applicable. In addition, when the cathode electrode layer 7 is faced upward like the seventh example, the electrolyte layer 6 and the cathode electrode layer 7 are also not required to be divided.

In this example, the electric current path from the cathode electrode layer 7 to the separator 13 is only the outer peripheral portion, but the second conductive region 9 is provided below the cell supporting portion 1601, and the electric collector 11 is further provided therebelow, so that the parasitic resistance can also be reduced. However, as the occupation area of the cell supporting portion 1601 is larger, the power generation area of the unit cell 3 is decreased, so that attention is necessary for that point.

### Example 16

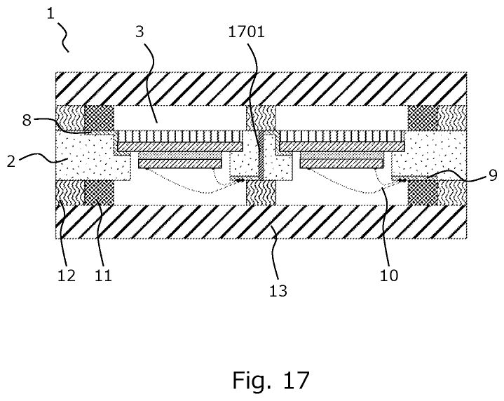

FIG. 17 is a cross-sectional view illustrating an example of the structure of the fuel cell of a sixteenth example of the present invention. In the fuel cell 1 of this example, a plurality of unit cells 3 are mounted on the same intermediate substrate 2, and a penetration electrode 1701 is provided to the intermediate substrate 2, so that they are connected in series.

According to this example, the fuel cell 1 can be caused to increase the output voltage and to decrease the output current, so that the power loss can be reduced. Typically, the power loss by the parasitic resistance is proportional to the square of the electric current value, so that in particular, when the electrolyte layer 6 is the thin film of 1 μm or less, the output current is large, and this effect becomes significant.

When all of the plurality of unit cells 3 mounted on the same intermediate substrate 2 are connected in series, the wiring can be complicated and insulation failure due to the increased output voltage of the stack in which the structure of the fuel cell 1 is repeatedly stacked in the vertical direction can occur, but when the unit cells 3 are disposed to be regularly arranged in two orthogonal directions like FIG. 12B, the unit cells 3 can be connected in parallel in each of the rows and be then connected in series between the rows, so that the wiring can be prevented from being complicated, and at the same time, the output voltage and the output current of each layer after the stack assembling can also be adjusted.

### Example 17

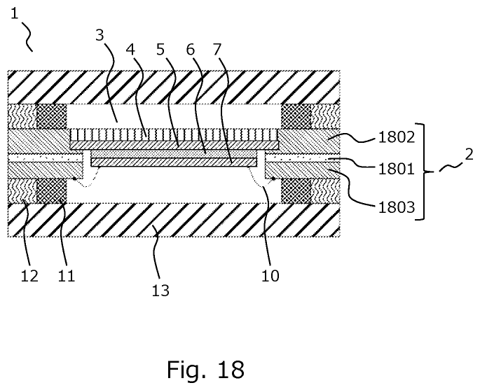

FIG. 18 is a cross-sectional view illustrating an example of the structure of the fuel cell of a seventeenth example of the present invention. In this example, the intermediate substrate 2 mainly includes a conductor, and has a three-layer structure preventing a short circuit between the anode and the cathode by an insulation layer 1801. Others are the same as the first example, the anode is connected to a first conductive layer 1802, and the cathode is connected to a second conductive layer 1803, so that the generated power is sent to the separator 13 through the electric collector 11. Also in this case, the width of the electrolyte layer 6 is made to be the maximum width or less of the hollow portion, so that the stress is not applied during the stack assembling and the breakage can be prevented.

### Example 18

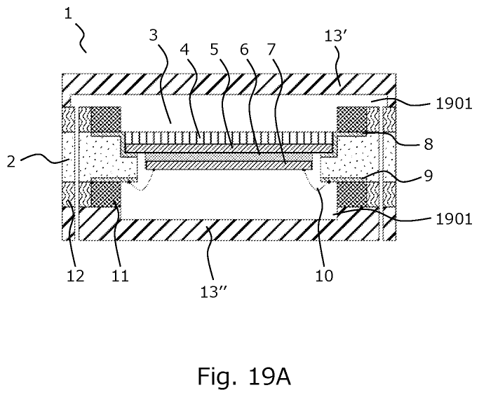

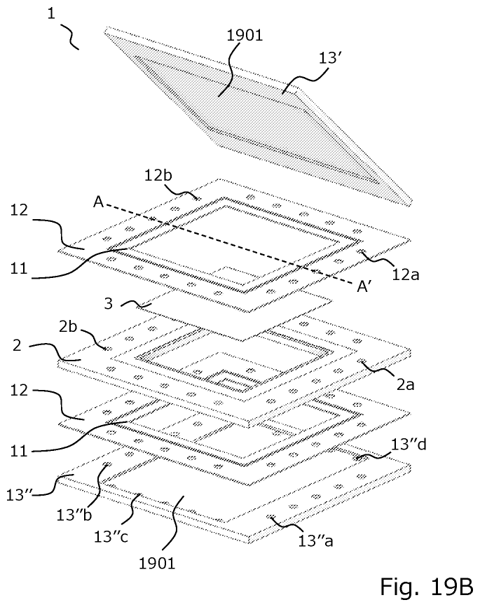

FIG. 19A is a cross-sectional view illustrating an example of the structure of the fuel cell of an eighteenth example of the present invention, and FIG. 19B is a perspective view. FIG. 19A illustrates the cross section taken along dashed line A-A′ in FIG. 19B, and in FIG. 19B, the topmost stage separator 13 is changed in angle in order to illustrate the state of the back face. In addition, when the topmost stage separator 13 and the lowermost stage separator 13 are required to be distinguished, the separator 13 disposed at the topmost stage is an anode side separator 13′ for description, and the separator 13 disposed at the lowermost stage is a cathode side separator 13″ for description.

In this example, flow passage groove portions 1901 are provided to the separator 13. Thus, the fuel gas and the air can be supplied to the unit cell 3 without providing the cutout portion in the gasket 12, and the flow passage of the gasket 12 has only a circular hole, thereby improving the sealability. In addition, when the counterbore portion of the intermediate substrate 2 is sharrow with respect to the thickness of the unit cell 3, and when the electric collector 11 and the gasket 12 are thin, the risk in which the unit cell 3 and the bonding wire 10 come into contact with the separator 13 can also be reduced.

When the air is supplied from an air flow inlet 13″c of the cathode side separator 13″, the air passes through the flow passage groove portion 1901 to be supplied to the unit cell 3, and is then discharged to the outside from an air flow outlet 13″d. The fuel gas passes through a fuel flow inlet 13″a of the cathode side separator 13″, a fuel flow inlet 12a of the gasket 12, and the fuel flow inlet 2a of the intermediate substrate 2 to reach the anode side separator 13′, and is supplied to the unit cell 3 by the flow passage groove portion 1901. Thereafter, the fuel gas is discharged to the outside through a fuel flow outlet 12b of the gasket 12, the fuel flow outlet 2b of the intermediate substrate 2, and a fuel flow outlet 13″b of the cathode side separator 13″.

When the same structure is repeatedly stacked like FIG. 5, the fuel flow inlet 13a, the fuel flow outlet 13b, the air flow inlet 13c, and the air flow outlet 13d are provided to the separator 13 at each stage, and further, the flow passage groove portions 1901 are provided on both faces. At this time, the depth of the flow passage groove portion 1901 is required to be less than half of the thickness of the separator 13.

According to the examples described above, the unit cell is mounted on the intermediate substrate different from the separator, and the electric connection with the separator is made through the intermediate substrate. According to the examples, the stress application to the cell during the stack assembling can be prevented. Further, the failure of the cell due to the breakage and the like of the electrolyte layer can be prevented. In addition, the electrolyte layer is made thinner, so that the output density can also be improved.

According to the examples, the high performance fuel cell can be achieved, the carbon exhaust amount can be reduced, and the global warming can be prevented, thereby contributing to the achievement of the sustainable society.

### LIST OF REFERENCE SIGNS

1 fuel cell
2 intermediate substrate
2a fuel flow inlet
2b fuel flow outlet
2c air flow inlet
2d air flow outlet
3 unit cell
4 porous support layer
5 anode electrode layer
6 electrolyte layer
7 cathode electrode layer
8 first conductive region
9 second conductive region
10 bonding wire
11 electric collector
12 gasket
12′ anode side gasket
12″ cathode side gasket
13 separator
13′ anode side separator
13″ cathode side separator
400 fuel cell stack
401 bottom face jig
402 gasket
403 top face jig
404 support pillar
405 fastening member
500 fuel cell stack
501 fuel cell
1601 cell supporting portion
1701 penetration electrode
1801 insulation layer
1802 first conductive layer
1803 second conductive layer
1901 flow passage groove portion

What is claimed is:

1. A fuel cell that is equipped with a unit cell including a structure in which an electrolyte layer is sandwiched between an anode electrode layer and a cathode electrode layer,
wherein the unit cell is disposed between a first member and a second member,
wherein an intermediate substrate is disposed between the first member and the second member,
wherein the unit cell is supported at the outer peripheral portion thereof by the intermediate substrate, and
wherein the width of the electrolyte layer is the maximum width or less of a hollow portion formed between at least one of the first member and the second member and the unit cell.

2. A fuel cell that is equipped with a unit cell including a structure in which an electrolyte layer is sandwiched between an anode electrode layer and a cathode electrode layer,
wherein the unit cell is disposed between a first member and a second member,
wherein an intermediate substrate is disposed between the first member and the second member,
wherein the unit cell is supported at the outer peripheral portion thereof by the intermediate substrate, and
wherein the thickness of the electrolyte layer is 1 μm or less.

3. The fuel cell according to claim 1, wherein the electrolyte layer is made of yttria stabilized zirconia.

4. The fuel cell according to claim 1, wherein the thickness of the anode electrode layer is 1 μm or less, and a porous support layer is present to be in contact with the anode electrode layer.

5. The fuel cell according to claim 4, wherein the porous support layer is made of an aluminum oxide.

6. The fuel cell according to claim 4, wherein the porous support layer is made of an alloy containing iron of 50% or more.

7. The fuel cell according to claim 6, wherein a metal material having air holes comes into contact with the porous support layer.

8. The fuel cell according to claim 1, wherein a first conductive region and a second conductive region are provided to the intermediate substrate.

9. The fuel cell according to claim 8, wherein the cathode electrode layer and the second conductive region are electrically connected by a bonding wire.

10. The fuel cell according to claim 1, wherein the metal material having the air holes comes into contact with the cathode electrode layer.

11. The fuel cell according to claim 1, wherein a cell supporting portion is provided so as to divide the through hole of the intermediate substrate.

12. The fuel cell according to claim 1, wherein a plurality of unit cells are mounted on one intermediate substrate.

13. The fuel cell according to claim 12, wherein the unit cell disposed on the downstream side of a fuel gas flow passage has generated power when the unit cell disposed on the downstream side is operated under the same condition as compared with the unit cell disposed on the upstream side.

14. The fuel cell according to claim 12, wherein of a plurality of unit cells mounted on one intermediate substrate, the anode electrode layer of at least one unit cell is electrically connected to the cathode electrode layer of the different unit cell mounted on the same intermediate substrate.

15. The fuel cell according to claim 1, wherein the hollow portions are formed in both between the first member and the unit cell and between the second member and the unit cell.

16. The fuel cell according to claim 1, wherein the thickness of the electrolyte layer is 1 μm or less.

17. A fuel cell stack that has the fuel cell according to claim 1 and applies compression stress from the up and down sides of the entire fuel cell.
